(19) United States
(12) Patent Application Publication
(10) Pub. No.: US 2015/0219436 A1
(43) Pub. Date: Aug. 6, 2015

(54) OPTICAL PROBE AND METHOD OF ATTACHING OPTICAL PROBE

(71) Applicant: Sumitomo Electric Industries, Ltd., Osaka-shi (JP)

(72) Inventors: Hiroshi OBI, Yokohama-shi (JP); Takemi HASEGAWA, Yokohama-shi (JP)

(21) Appl. No.: 14/607,489

(22) Filed: Jan. 28, 2015

(30) Foreign Application Priority Data
Jan. 31, 2014 (JP) 2014-017210

(51) Int. Cl. G01B 9/02

(52) U.S. Cl. CPC G01B 9/02049; G01B 9/02091

(57) ABSTRACT

An optical probe includes an optical fiber that rotates around an axis of rotation and that transmits light; an optical connector that is connected to an end face of the optical fiber and that rotates together with the optical fiber; a supporting tube that surrounds the optical fiber and that rotates together with the optical fiber; a jacket tube that covers the supporting tube; an inner shell that is attached to the supporting tube, that surrounds the optical connector around the axis of rotation, and that rotates together with the optical fiber; an outer shell that is attached to the jacket tube and that surrounds the inner shell; and an elastic body that elastically deforms between the inner shell and the outer shell.

### BACKGROUND OF THE INVENTION

1. Field of the Invention

The present invention relates to an optical probe and a method of attaching the optical probe.

2. Description of the Related Art

Optical coherence tomography (OCT) is a technology for measuring cross-sectional structure. When measuring the cross-sectional structure of a lumen, such as a blood vessel, of a living body as an object, an optical probe is inserted into the lumen (see, for example, U.S. Pat. No. 6,445,939B, US2002/015823A, and WO2009/154103). For example, an optical probe includes an optical fiber and a graded-index optical fiber. The graded-index optical fiber, which is disposed at an end of the optical fiber. serves as a condenser lens. The optical probe is structured so as to have a working distance of I mm or greater and a spot size of 100 μm or smaller. Thus, OCT can provide a tomographic image of a living object as an object, having an inside radius of 1 mm or smaller, with a spatial resolution of 100 μm or smaller.

OCT technology is also used to select a therapy by diagnosing a lesion in a blood vessel. By using OCT technology, a tomographic image of a lesion can be obtained. For example, the tomographic image is provided as a monochrome image including bright portions, indicating parts in the lesion that strongly scatter light, and dark portions, indicating parts in the lesion that weakly scatter light. The pattern of distribution of the bright portions and the dark portions in the tomographic image differs depending on the type of a lesion, enabling the type of the lesion to be estimated with some degree of accuracy (see, for example, W. M. Suh et al., “Intravascular Detection of the Vulnerable Plaque”. Circ Cardiovasc Imaging, March 2011, pp. 169-178).

Usually, an optical probe is attached to a driver for performing a rotational scanning operation and a pullback operation. Because the optical probe is discarded after a single use, an operator needs to attach an optical probe to the driver each time when performing imaging. Moreover, because the driver is disposed near a patient, a sterile cover is placed over the driver when the driver is used. Accordingly, it is desirable that the optical probe be easily attachable without the need to carry out careful manual work. Therefore, it is desirable that, when attaching an optical probe, automatic fitting be performed as follows: an adapter in the driver automatically approaches an optical connector of the optical probe, and the adapter contacts the optical connector to become optically coupled to the optical connector. However, with such automatic fitting, the adapter might not become optically coupled to the optical connector sufficiently, and therefore, it may be difficult to perform the operation of attaching an optical probe, which needs to be performed frequently.

### SUMMARY OF THE INVENTION

The present invention provides an optical probe and a method of attaching the optical probe, with which an optical connector and an adapter can be automatically fitted to each other easily.

In order to solve the problem, there is provided an optical probe including an optical fiber that rotates around an axis of rotation and that transmits light; an optical connector that is connected to an end face of the optical fiber and that rotates together with the optical fiber around the axis of rotation; a supporting tube that surrounds the optical fiber and that rotates together with the optical fiber around the axis of rotation; a jacket tube that covers the supporting tube, an inner shell that is attached to the supporting tube, that surrounds the optical connector around the axis of rotation, and that rotates together with the optical fiber around the axis of rotation; an outer shell that is attached to the jacket tube and that surrounds the inner shell around the axis of rotation; and an elastic body that is attached to one of the inner shell and the outer shell and that elastically deforms between the inner shell and the outer shell.

According to another aspect of the present invention, there is provided an optical probe including an optical fiber that rotates around an axis of rotation and that transmits light; an optical connector that is connected to an end face of the optical fiber and that rotates together with the optical fiber around the axis of rotation; a supporting tube that surrounds the optical fiber and that rotates together with the optical fiber around the axis of rotation; a jacket tube that covers the supporting tube; an inner shell that is attached to the supporting tube, that surrounds the optical connector around the axis of rotation, and that rotates together with the optical fiber around the axis of rotation; and an outer shell that is attached to the jacket tube and that surrounds the inner shell around the axis of rotation. At least one of the inner shell and the outer shell includes an elastic structure that is integrally formed with the inner shell or the outer shell, at least a part of the elastic structure elastically deforming when the inner shell and the outer shell contact each other.

It is preferable that the optical probe according to the present invention be an optical probe to be attached to a driver that includes an automatic-fitting portion including a moving part for automatic fitting and an adapter, and a case containing the automatic-fitting portion; that the moving part for automatic fitting include a stage that moves the adapter along the axis of rotation and a motor that rotates the adapter around the axis of rotation; that the adapter become coupled to the optical connector by movement of the stage along the axis of rotation; that the inner shell of the optical probe rotate around the axis of rotation as the motor rotates around the axis of rotation; and that the outer shell be detachably attached to the case.

According to the present invention, a method of attaching the optical probe according the present invention to the driver includes a first step of attaching the outer shell to the case of the driver; and a second step of automatically fitting the adapter to the optical connector by moving the adapter along the axis of rotation toward the optical connector by using the stage of the moving part for automatic fitting.

With the optical probe and the method of attaching the optical probe according to the present invention, the optical connector and the adapter can be automatically fitted to each other easily.

### BRIEF DESCRIPTION OF THE DRAWINGS

FIG. 1 is a conceptual diagram of an OCT system including an optical probe according to an embodiment of the present invention.

FIG. 2A is a plan view illustrating the overall structure of the optical probe, and FIG. 2B is a side view illustrating an end of the optical probe seen from an opening in an outer shell of the optical probe.

FIG. 3 is a conceptual diagram illustrating a state in which a jacket tube is pulled back.

FIG. 4 is a sectional side view of a driver, illustrating a state in which the optical probe is connected to the driver.

FIG. 5 is a conceptual diagram illustrating the shape of a connection hole seen from a direction in which the optical probe is inserted.

FIG. 6 is a conceptual diagram illustrating an operation of the driver and the optical probe.

FIG. 7 is a conceptual diagram illustrating an operation of the driver and the optical probe.

FIG. 8 is a conceptual diagram illustrating an operation of the driver and the optical probe.

FIG. 9 is a conceptual diagram illustrating an operation of the driver and the optical probe.

FIG. 10 is a conceptual diagram illustrating an operation of the driver and the optical probe.

FIG. 11 is a flowchart representing the process of attaching the optical probe to the driver.

FIGS. 12A and 12B are conceptual diagrams illustrating a state before an adapter and an optical connector of an optical probe according to a first modification contact each other, FIG. 12A showing a front view of an end of the optical probe seen from an opening in an outer shell, and FIG. 12B showing a sectional view taken along line XIIB-XIIB.

FIGS. 13A and 13B are conceptual diagrams illustrating a state after the adapter and the optical connector of the optical probe according to the first modification have been automatically fitted to each other, FIG. 13A showing a front view of the end of the optical probe seen from the opening in the outer shell, and FIG. 13B showing a sectional view taken along line XIIIB-XIIIB.

FIGS. 14A and 14B are conceptual diagrams illustrating a state before an adapter and an optical connector of an optical probe according to a second modification contact each other, FIG. 14A showing a front view of an end of the optical probe seen from an opening in an outer shell, and FIG. 14B showing a sectional view taken along line XIVB-XIVB.

FIGS. 15A and 15B are conceptual diagrams illustrating a state after the adapter and the optical connector of the optical probe according to the second modification have been automatically fitted to each other, FIG. 15A showing a front view of the end of the optical probe seen from the opening in the outer shell, and FIG. 15B showing a sectional view taken along line XVB-XVB.

FIG. 16A is a front view of an end of an optical probe according to a further modification of the second modification seen from an opening in an outer shell, and FIG. 16B is a perspective view of an inner shell and the outer shell.

FIG. 17A is a front view of an end of an optical probe according to a further modification of the second modification seen from an opening in an outer shell, and FIG. 17B is a perspective view of an inner shell and the outer shell.

### DESCRIPTION OF THE PREFERRED EMBODIMENTS

Hereinafter, specific examples of an optical probe and a method of attaching the optical probe according to embodiments of the present invention will be described with reference to the drawings. The scope of the present invention, which is represented by the claims, is not limited to these examples, and it is intended that the scope encompasses all modifications within the meaning of the claims and the equivalents thereof. In the following description, the same elements in the drawings will be denoted by the identical numerals and redundant descriptions of such elements will be omitted.

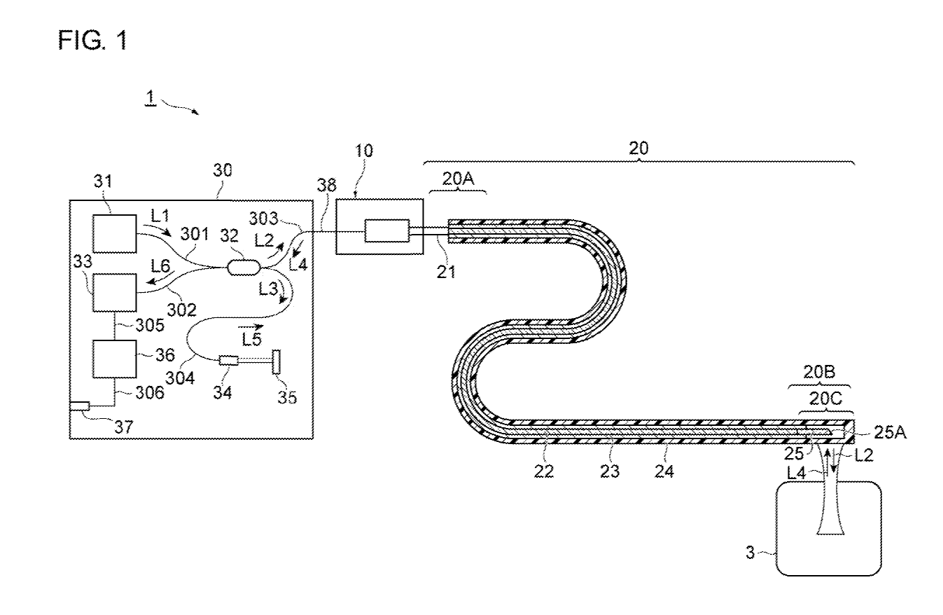

FIG. 1 is a conceptual diagram of an OCT system 1 including an optical probe according to an embodiment. The OCT system 1 includes a driver 10, an optical probe 20, and a measuring unit 30. The OCT system 1 obtains a tomographic image of a living body 3 as an object. In FIG. 1, an inner shell and an outer shell (described below) are omitted. The optical probe 20 includes one end 20A and the other end 20B in the longitudinal direction. The end 20A includes an optical connector 21. The optical probe 20 is optically connected to the driver 10 through the optical connector 21. The end 20B includes an optical measurement unit 20C.

The optical probe 20 includes an optical fiber 22, a supporting tube 23, and a jacket tube 24. The optical fiber 22 and an optical deflection member 25 are enclosed in the supporting tube 23, which has a cylindrical shape. The supporting tube 23 is fixed to at least a part of the optical fiber 22 and to the optical connector 21. Therefore, when the optical connector 21 rotates, the rotational torque of the optical connector 21 is transmitted through the supporting tube 23 to the optical fiber 22 and to the optical deflection member 25, and these rotate together. Due to the rotation, the living body 3 as an object is irradiated with illuminating light L2 emitted from the optical deflection member 25. The jacket tube 24, having a cylindrical shape, surrounds the optical fiber 22, the optical deflection member 25, and the supporting tube 23; and forms an outermost part of the optical probe 20. The jacket tube 24 does not rotate and remains at rest when the optical probe 20 performs a rotational scanning operation and a pullback operation. While rotating, the optical fiber 22, the optical deflection member 25, and the supporting tube 23 do not contact the living body 3 as an object, and therefore, damage to the living body 3 as an object is avoided.

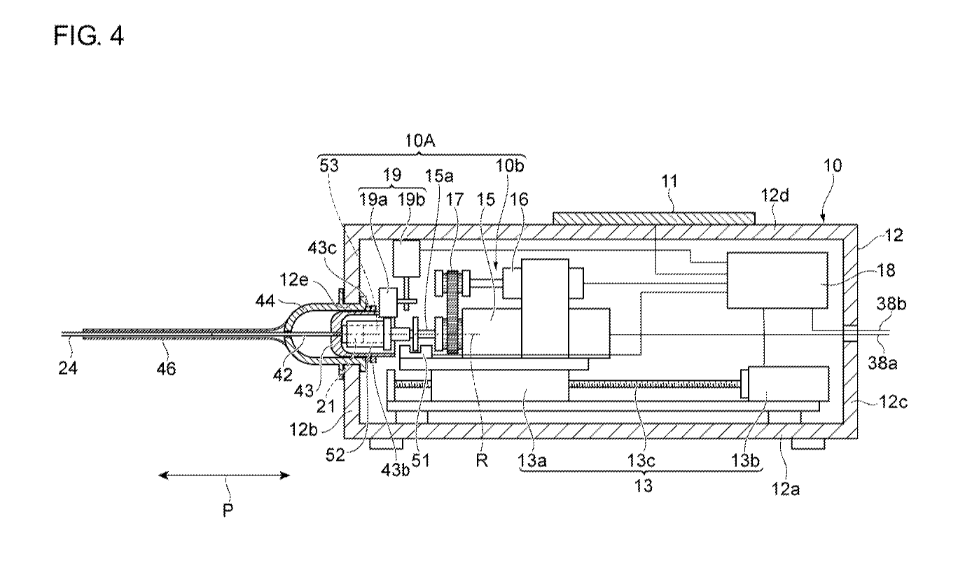

The measuring unit 30 includes a light source 31, a 2×2 optical coupler 32, an optical detector 33, an optical terminal 34, a reflecting mirror 35, an analyzer 36, and an output port 37. The measuring unit 30 further includes a cable 38 and waveguides 301 to 304. The cable 38 couples the measuring unit 30 and the driver 10 to each other. The waveguide 301 optically couples the light source 31 and the 2×2 optical coupler 32 to each other. The waveguide 302 optically couples the 2×2 optical coupler 32 and the optical detector 33 to each other. The waveguide 303 optically couples the 2×2 optical coupler 32 and a rotary joint 15 (see FIG. 4) to each other via the cable 38. The driver 10 is optically coupled to the optical connector 21. The waveguide 304 optically couples the 2×2 optical coupler 32 and the optical terminal 34 to each other. The optical detector 33 and the analyzer 36 are electrically connected to each other through a signal wire 305, and the analyzer 36 and the output port 37 are electrically connected to each other through a signal wire 306.

The light source 31 generates low coherence light L1. After being guided along the waveguide 301., the low coherence light L1 is split by the 2×2 optical coupler 32 into illuminating light L2 and reference light L3.

After being guided along the waveguide 303, the illuminating light L2 passes through the cable 38, the driver 10, and the optical connector 21; and the illuminating light L2 enters one end of the optical fiber 22 in the optical probe 20. After exiting from the other end of the optical fiber 22, the illuminating light L2 is deflected by the optical deflection member 25 and transmitted through the jacket tube 24; and the living body 3 as an object, such as a blood vessel, is irradiated with the illuminating light L2. The living body 3 as an object reflects the illuminating light L2, thereby generating reflected light L4. The reflected light L4 passes through the optical deflection member 25 and is guided along the optical fiber 22 in a direction opposite to that of the illuminating light L2. The reflected light LA passes through the optical connector 21, the driver 10, and the cable 38; and the reflected light L4 enters the waveguide 303 and is guided into the 2×2 optical coupler 32. The reflected light L4 is guided from the 2×2 optical coupler 32 to the waveguide 302, and is guided into the optical detector 33. The reference light L3 passes through the waveguide 304; and the reference light L3 is emitted from the optical terminal 34 and reflected by the reflecting mirror 35 to become reflected reference light L5. The reflected reference light L5 passes through the optical terminal 34 and the waveguide 304, and is guided into the 2×2 optical coupler 32.

The reflected light L4 and the reflected reference light L5 interfere with each other in the 2×2 optical coupler 32, thereby generating interference light L6. The interference light L6 is guided from the 2×2 optical coupler 32, to the waveguide 302, and into the optical detector 33.

The optical detector 33 detects the intensity (spectrum) of the interference light L6 corresponding to wavelength. A detection signal representing the spectrum of the interference light L6 is input to the analyzer 36 through the signal wire 305. The analyzer 36 analyzes the spectrum of the interference light L6 and calculates the distribution of reflection efficiency at points in the living body 3 as an object. On the basis of the calculation result, the analyzer 36 obtains a tomographic image of the living body 3 as an object and outputs an image signal representing the tomographic image. The image signal is output from the output port 37 to the outside of the OCT system 1.

Because the reflected light L4 from the living body 3 as an object and the reference light L3 pass along different optical paths, the wavelength dispersion along the optical paths of the reflected light L4 and the reference light L3 may differ from each other. If the wavelength dispersion differs, the group delay time of light differs according to the wavelength. The body of the OCT system calculates an autocorrelation function as a function of a group delay time by performing Fourier analysis on the spectrum as a function of a wavelength, and generates a tomographic image on the basis of the calculation result. Therefore, if the group delay time differs according to the wavelength, the spatial resolution of the tomographic image is reduced. In the present embodiment, a reference object, such as a mirror, is measured before measuring the living body 3 as an object. Thus, the effect of wavelength dispersion is estimated, and data processing is performed so as to compensate for the wavelength dispersion.

Examples of a mechanism by which the illuminating light L2, after having been emitted toward the living body 3 as an object, returns to the optical deflection member 25 include not only reflection by the living body 3 as an object, but also refraction, scattering, and the like. However, the difference in the mechanism does not affect the process of obtaining an image signal according to the present embodiment. Therefore, in FIG. 1, light that returns to the optical deflection member 25 is collectively represented as the reflected light L4.

The optical fiber 22 of the optical probe 20 has a length in the range of 1 m to 2 m, and is made of, for example, a silica glass. The optical fiber 22 has a transmission loss of 1 dB or less in a wavelength range of 1.6 μm to 1.8 μm. The optical fiber 22 has a cutoff wavelength of 1.53 μm or less, and can perform a single-mode operation in the wavelength range of 1.6 μm to 1.8 μm. It is preferable that the optical fiber 22 be compliant with ITU-T G.652, G.654, and G.657. It is more preferable that the optical fiber 22 be compliant with ITU-T G.654A or C. An optical fiber that is compliant with ITU-T G.654A or C has a transmission loss of 0.22 dB/km or less at a wavelength of 1.45 μm, and includes a core that is mainly made pure silica glass. Therefore, the optical fiber has a low nonlinear optical coefficient, and can reduce noise due to non-linear optical effects, such as self-phase modulation.

The optical deflection member 25 may also have the function of a condenser lens. For example, by adjusting the optical deflection member 25 so as to have a refractive index distribution as a graded index (GRIN) lens, the optical deflection member 25 can appropriately function as a condenser lens. The size of a spot formed by the illuminating light L2 is reduced, and therefore, a tomographic image of a very small region of the living body 3 as an object can be obtained. For example, the optical deflection member 25 is made of a silica glass or a borosilicate glass, and has a transmission loss of 2 dB or less in the wavelength range of 1.6 μm to 1.8 μm. A reflecting surface 25A of the optical deflection member 25 is a flat surface formed on a cylindrical glass so as to have an angle in the range of 35 to 55 degrees with respect to the axis of the cylindrical glass. The reflecting surface 25A can reflect light by total reflection. It is preferable that aluminum or gold be deposited on the reflecting surface 25A in order to increase the reflectance in a wavelength range of 1.6 μm to 1.8 μm.

As described above, the optical fiber 22, the optical deflection member 25, and the supporting tube 23 rotate together. Therefore, as compared with a case where only the optical fiber 22 rotates, a torque applied to the optical fiber 22 is reduced and breakage of the optical fiber 22 due to the torque can be prevented. It is preferable that the supporting tube 23 have a thickness of 0.15 mm or greater and a Young's modulus in the range of 100 GPa to 300 GPa, which is equivalent to that of stainless steel. It is not necessary that the supporting tube 23 be continuous in the circumferential direction. The supporting tube 23 may have a structure in which 5 to 20 wires are twisted, thereby allowing the flexibility of the supporting tube 23 to be adjusted.

It is preferable that the jacket tube 24 be made of, for example, a fluorocarbon resin plastic (such as FEP, PFA, or PTFE), polyethylene terephthalate (PET), or nylon. It is preferable that the jacket tube 24 have a thickness in the range of 10 μm to 50 μm and have a transmission loss of 2 dB or less in the wavelength range of 1.6 μm to 1.8 μm. It is preferable that a space between the supporting tube 23 and the jacket tube 24 be filled with a buffer fluid. The buffer fluid reduces friction between an outer surface of the supporting tube 23, which rotates, and an inner surface of the jacket tube 24. Moreover, the buffer fluid adjusts a change in the refractive index along an optical path between the optical deflection member 25 and the jacket tube 24. It is preferable that the buffer fluid have a transmission loss of 2 dB or less in the wavelength range of 1.6 μm to 1.8 μm. Examples of the buffer fluid include, for example, saline water, dextran solution, and silicone oil.

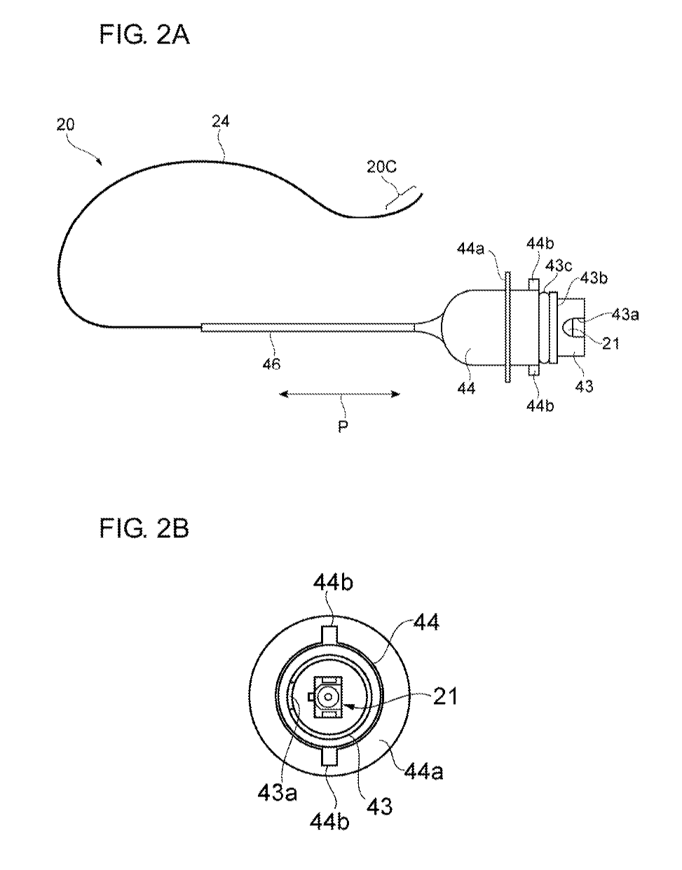

FIG. 2A is a plan view illustrating the overall structure of the optical probe 20. Because the optical probe 20 is discarded after a single use, the optical probe 20 is detachable from the driver 10 and is replaced after each use. The optical probe 20 includes a sheath 46, an inner shell 43, an outer shell 44, and the optical connector 21. The optical probe 20 is detachably attached to the driver 10 via the outer shell 44. FIG. 2B is a side view illustrating the end 20A of the optical probe 20 seen from the opening in the outer shell 44 of the optical probe 20.

As illustrated in FIG. 1, the optical probe 20 includes the optical fiber 22, the supporting tube 23, the optical deflection member 25, and the jacket tube 24 that surrounds these. The optical measurement unit 20C, for irradiating the inside of a patient's body with light, is disposed at a distal end of the optical probe 20. As illustrated in FIG. 2A, the sheath 46 is a tubular member that is disposed between the jacket tube 24 and the outer shell 44 and that contains the optical fiber 22. The optical fiber 22 is disposed inside the sheath 46 so as to be movable in the longitudinal direction so that the optical probe 20 can perform a rotational scanning operation and a pullback operation. The sheath 46 remains at rest when the optical probe 20 performs a rotational scanning operation and a pullback operation.

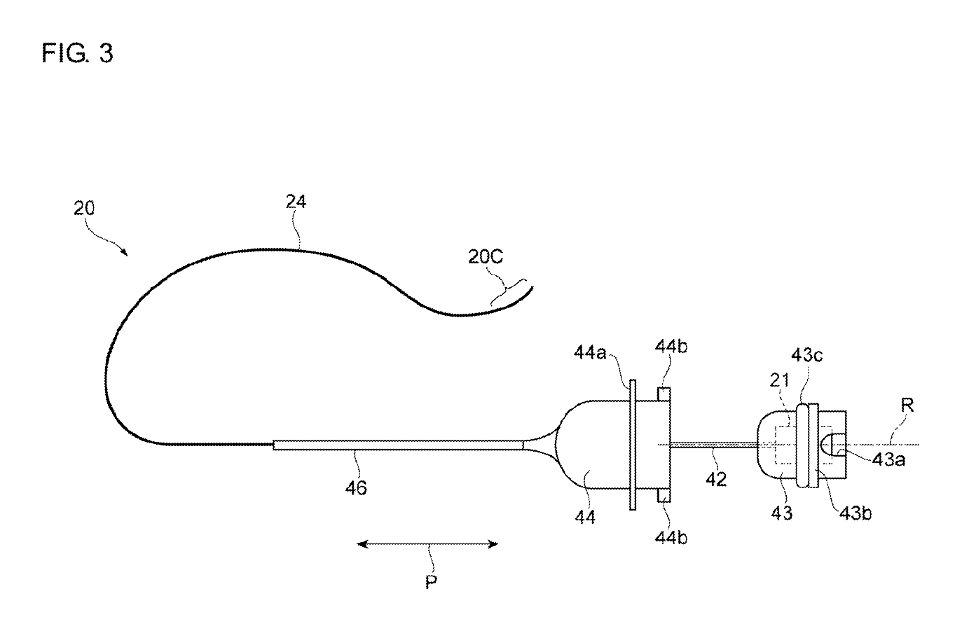

FIG. 3 is a conceptual diagram illustrating a state in which the optical fiber 22 is pulled back. A part of the optical fiber 22 exposed from the sheath 46 when the optical fiber 22 is pulled back is protected by a metal tube 42. The metal tube 42 functions as a rotation shaft in a rotational scanning operation when pulled back. It is preferable that the metal tube 42 be made of a NiTi alloy, which is superelastic, so that the metal tube 42 can revert to its original shape without yielding even if a strong bending stress is generated.

The inner shell 43, the outer shell 44, and the optical connector 21 are disposed at an end of the optical probe 20 to be connected to the driver 10. The optical connector 21 is attached to an end of the optical fiber 22 on the driver 10 side. By being coupled to an adapter (described below) of the driver 10, the optical connector 21 allows light to be transferred between the adapter and the optical fiber 22 therethrough. The optical connector 21 rotates together with the optical fiber 22 and is movable along an arrow P. For example, an SC connector, which becomes fitted only by being pushed, may be used as the optical connector 21. It is preferable that the optical connector 21 be angled-PC polished (APC) for antireflection.

The inner shell 43 surrounds the optical connector 21 around the axis R of rotation of the optical connector 21. The inner shell 43 extends in the longitudinal direction of the optical probe 20 and has a substantially cylindrical shape in which an end thereof on the metal tube 42 side is hemispherically closed. As with the optical connector 21, the inner shell 43 rotates together with the optical fiber 22 and is movable along the arrow P.

The inner shell 43 has a cutout 43a extending in the longitudinal direction of the optical probe 20. The cutout 43a is formed in an end of the inner shell 43 on the driver 10 side. A key member 19a of a stopper mechanism 19 (see FIG. 4), which will be described below, is inserted into the cutout 43a.

The inner shell 43 includes a flange 43b. The flange 43b is disposed along an outer peripheral surface of the inner shell 43 and extends in a plane perpendicular to the longitudinal direction of the optical probe 20. The outside diameter of the flange 43b is larger than the inside diameter of the outer shell 44 described below. Therefore, an end of the inner shell 43 to be connected to the driver 10 always protrudes from an end of the outer shell 44. The flange 43b regulates the length of a part of the inner shell 43 that is inserted into the outer shell 44.

An elastic body 43c is attached to the flange 43b on an outer peripheral surface of the inner shell 43, that is, a facing surface of the inner shell 43 that faces the outer shell 44. The elastic body 43c elastically deforms between the inner shell 43 and the outer shell 44. It is preferable that the elastic body 43c be made of, for example, a fluorocarbon rubber or a silicone rubber. It is preferable that the elastic body 43c have hardness (Shore A) in the range of A50 to A90. A fluorocarbon rubber and a silicone rubber both have a hardness of A70. Basically, the elastic body 43c may be made of any material as long as the Shore A of the material is in the range of A50 to A90. It is preferable that the elastic body 43c be made of, for example, a fluorocarbon rubber (A60 to A80), such as Viton; a silicone (A50 to A70); a nitrile rubber (A50 to A70); or a urethane (A50 to A90). It is preferable that the elastic body 43c be formed as, for example, an O-ring.

The outer shell 44, for containing the inner shell 43, serves as a protector for preventing an operator from directly contacting rotary parts, such as the inner shell 43 and the optical connector 21. The outer shell 44 is attached to an end of the sheath 46 on the driver 10 side. The outer shell 44 remains at rest together with the sheath 46 when the optical probe 20 performs a rotational scanning operation and a pullback operation. The outer shell 44 is shaped so as to surround the inner shell 43 around the axis R of rotation. In one example, the outer shell 44 extends coaxially with the inner shell 43 and has a substantially cylindrical shape in which an end thereof on the sheath 46 side is hemispherically closed. The inner shell 43 can be inserted into and extracted from an opening in the cylindrical shape.

The outer shell 44, which is a connection member in the present embodiment, is removably connected to the driver 10. Therefore, the outer shell 44 includes a flange portion 44a and tab portions 44b.

The flange portion 44a has a substantially annular shape extending in a plane perpendicular to the longitudinal direction of the optical probe 20. The flange portion 44a is disposed along an outer peripheral surface of the outer shell 44. The outside diameter of the flange portion 44a is greater than the inside diameter of a connection hole 12e (see FIG. 4) of the driver 10. When the outer shell 44 is inserted into the connection hole 12e, the flange portion 44a contacts the periphery of the connection hole 12e and positions the outer shell 44 in the insertion direction.

The tab portions 44b are disposed between an end of the outer shell 44 and the flange portion 44a so as to protrude from the outer peripheral surface of the outer shell 44 in a direction perpendicular to the longitudinal direction of the optical probe 20. By engaging with hooks (described below) formed in the connection hole 12e of the driver 10, the tab portions 44b prevent the outer shell 44 from coming off the driver 10. In the figures, two tab portions 44b, which are disposed so as to be separated from each other by 180° in the circumferential direction, are illustrated as an example. However, the number of the tab portions 44b may be any appropriate number, and, if the number is more than one, it is preferable that the tab portions 44b be arranged in the circumferential direction.

FIG. 4 is a sectional side view of the driver 10 in a state in which the optical probe 20 is connected to the driver 10. The driver 10 includes an automatic-fitting portion 10A and a case 12 containing the automatic-fitting portion 10A. The automatic-fitting portion 10A includes a moving part 10b for automatic fitting and an adapter 53. The moving part 10b for automatic fitting includes a stage 13, the rotary joint 15, a motor 16, a rotation transmitting belt 17, a controller 18, the stopper mechanism 19, and a rotation angle sensor 51. The controller 18 controls the stage 13, the motor 16, and the stopper mechanism 19. The controller 18 is connected to the measuring unit 30 through a wire 38b included in the cable 38 (see FIG. 1).

The case 12, which has a hollow and substantially rectangular-parallelepiped shape, includes a bottom plate 12a, a top plate 12d, a front plate 12b, and a rear plate 12c. An operation panel 11, which is used by an operator to control the driver 10, is disposed on a surface of the top plate 12d. The operation panel 11 is electrically connected to the controller 18. The connection hole 12e is formed in the front plate 12b.

The stage 13, which is a mechanism for moving the adapter 53 away from the outer shell 44, is disposed on the bottom plate 12a in the case 12. The stage 13 includes a forward-backward driving motor 13b for rotating a feed screw 13c and a forward-backward driving stage 13a that moves in accordance with the amount of rotation of the feed screw 13c. The controller 18 controls the amount of rotation of the forward-backward driving motor 13b. The rotary joint 15, the motor 16, and the rotation angle sensor 51 are disposed on the forward-backward driving stage 13a. The adapter 53 and an adapter head 52 covering the adapter 53 are attached to the rotary joint 15. When the optical probe 20 performs a pullback operation and when the optical probe 20 is removed from the driver 10, the stage 13 moves the adapter 53 away from the outer shell 44.

The rotary joint 15 optically couples an optical fiber 38a, which is included in the cable 38 (see FIG. 1), to the adapter 53. A coupling shaft 15a of the rotary joint 15, which is to be connected to the adapter 53, is rotatable around the axis R of rotation. A rotation shaft of the motor 16 is connected to the coupling shaft 15a through the rotation transmitting belt 17, so that the power of the motor 16 is transmitted to the coupling shaft 15a. The motor 16 is disposed on the rotary joint 15. The controller 18 (rotation controller) controls the rotation of the motor 16.

The rotation angle sensor 51, which is a rotation angle measuring unit in the present embodiment, detects the rotation angle of the adapter 53 around the axis R of rotation. Preferably, the rotation angle sensor 51 is, for example, a rotary encoder attached to the coupling shaft 15a. The rotation angle sensor 51 sends a signal representing the detected rotation angle of the adapter 53 to the controller 18. The controller 18 controls the rotation of the motor 16 on the basis of the signal from the rotation angle sensor 51.

By being coupled to the optical connector 21 of the optical probe 20, the adapter 53 allows light to be transferred between the adapter 53 and the optical fiber 22 of the optical probe 20. The adapter 53 is attached to an end of the coupling shaft 15a of the rotary joint 15. The adapter 53 rotates together with the coupling shaft 15a, and transmits the rotational force of the coupling shaft Sa to the supporting tube 23 of the optical probe 20. The adapter 53 is moved by the forward-backward driving stage 13a and thereby moves the supporting tube 23 along the arrow P. The adapter 53 is covered by the adapter head 52, which has a cylindrical shape and surrounds the adapter 53 around the axis R of rotation.

When the optical probe 20 performs a pullback operation, the stopper mechanism 19 allows the optical connector 21 to move together with the adapter 53. When the optical probe 20 is removed from the driver 10, the stopper mechanism 19 prevents the optical connector 21 from being pulled out by the adapter 53. The stopper mechanism 19 includes the key member 19a and a key driving unit 19b. By being inserted into the cutout 43a (see FIGS. 2A, 2B, and 3) of the inner shell 43, the key member 19a prevents the inner shell 43 and the optical connector 21 from being pulled out by the adapter 53. When the key member 19a is extracted from the cutout 43a, the inner shell 43 and the optical connector 21 become movable along the arrow P and move together with the adapter 53.

When the optical probe 20 performs a pullback operation, the key member 19a is not inserted into the cutout 43a but is in an extracted state and allows a pullback operation of the optical connector 21 and the jacket tube 24 to be performed. When an operator removes the optical probe 20 from the driver 10, the key member 19a is inserted into the cutout 43a and prevents movement of the inner shell 43 and the optical connector 21.

The key driving unit 19b is an actuator for moving of the key member 19a. In accordance with an instruction from the controller 18, the key driving unit 19b moves the key member 19a in a direction crossing the axis R of rotation.

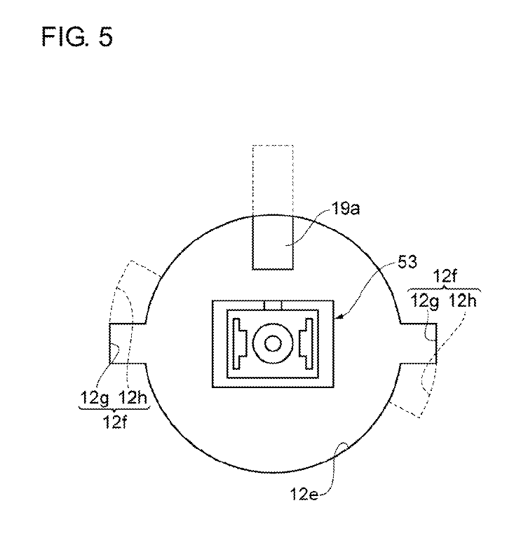

FIG. 5 is a conceptual diagram illustrating the shape of the connection hole 12e seen from a direction from which the optical probe 20 is inserted. The connection hole 12e has a substantially circular shape, which corresponds to the substantially cylindrical shape of the outer shell 44 and which has the center on the axis of the adapter 53 (that is, the axis R of rotation in FIG. 4). When an operator removes the optical probe 20 from the driver 10, the key member 19a protrudes into the connection hole 12e and engages with the inner shell 43.

FIG. 5 illustrates two hooks 12f, which are formed at the edge of the connection hole 12e. Each of the hooks 12f includes a hook insertion groove 12g and a hook engagement portion 12h. The hook insertion grooves 12g, each having a shape that matches the shape of a corresponding one of the tab portions 44b of the outer shell 44, are formed in an outer periphery of the connection hole 12e. The hook engagement portions 12h, each being continuous with a corresponding one of the hook insertion grooves 12g, extend in the circumferential direction. When the outer shell 44 is inserted into the connection hole 12e, the tab portions 44b pass through the hook insertion grooves 12g as the outer shell 44 is squeezed. Subsequently, the outer shell 44 is rotated, for example, by an angle in the range of 15° to 45°. As a result, the tab portions 44b engage with the hook engagement portions 12h to be fixed, and the outer shell 44 can be locked in this state.

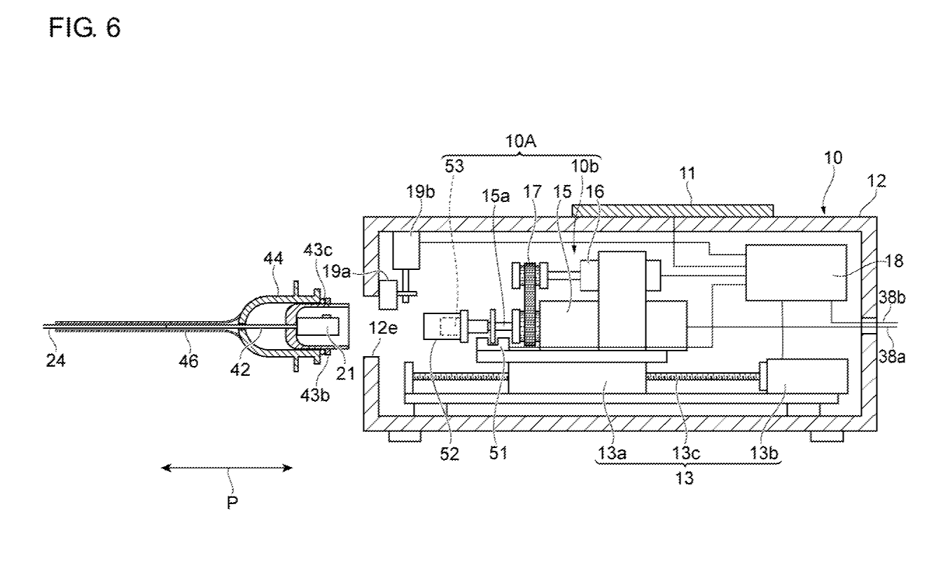

The operation of the OCT system 1, which has the above structure, will be described. FIGS. 6 to 10 are conceptual diagrams illustrating operations of the driver 10 and the optical probe 20. First, as illustrated in FIG. 6, a replacement optical probe 20 is prepared. In the driver 10, to which the optical probe 20 has not been connected, the controller 18 causes the stage 13 to keep the adapter 53 at a withdrawn position. The controller 18 causes the key member 19a to be moved to a position corresponding to that of the cutout 43a of the inner shell 43. Moreover, the controller 18 controls the rotation angle of the motor 16 so that the angle of the adapter 53 detected by the rotation angle sensor 51 coincides with the angle of the optical connector 21 in a state in which the key member 19a is inserted into the cutout 43a (in other words, so that the angles of the adapter 53 and the optical connector 21 coincide with each other in a state in which the position of the cutout 43a in the circumferential direction coincides with that of the key member 19a).

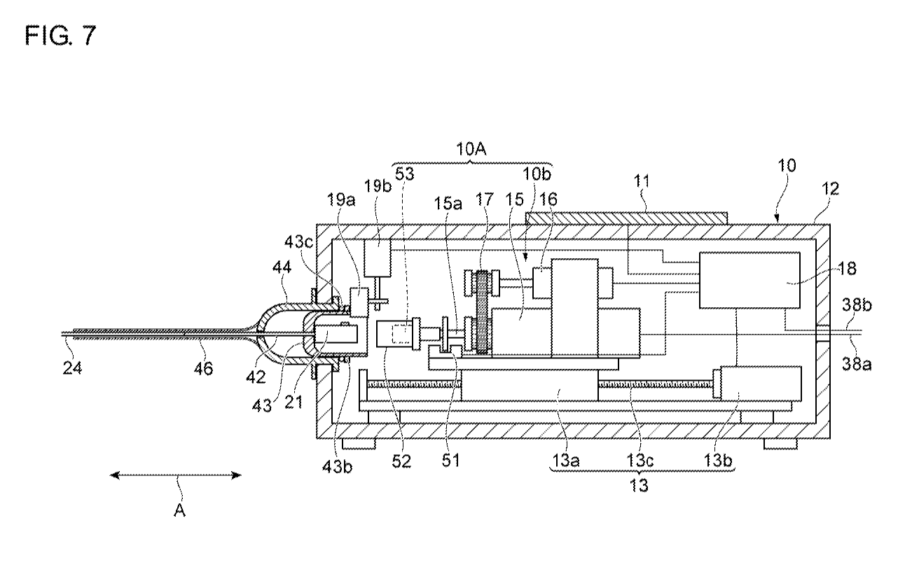

Next, as illustrated in FIG. 7, an operator inserts the inner shell 43 and the outer shell 44 of the optical probe 20 into the connection hole 12e of the driver 10. Simultaneously, the optical connector 21 is inserted into the case 12. The tab portions 44b, illustrated in FIGS. 2A and 2B, engage with the hooks 12f, and thereby the outer shell 44 is fixed to the case 12. At this time, the inner shell 43 is inserted so that the position of the cutout 43a of the inner shell 43 coincides with the position of the key member 19a, and thereby the rotational position of the optical connector 21 can be determined. Such an operation is preferable for a case where the orientations of the optical connector 21 and the adapter 53 when they are coupled to each other are limited and it is necessary to align these orientations.

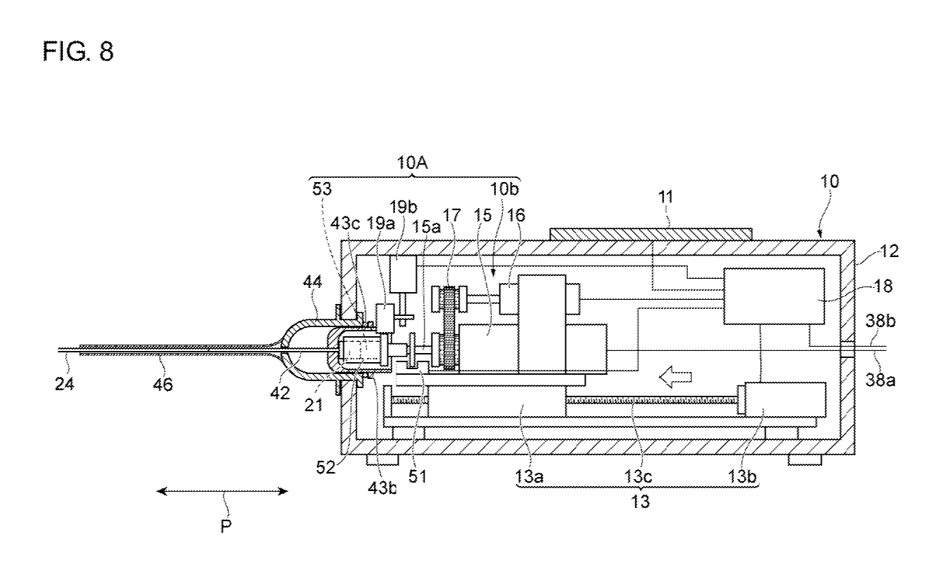

Next, as illustrated in FIG. 8, the controller 18 causes the stage 13 to move the adapter 53 forward to connect the adapter 53 and the optical connector 21 to each other. At this time, the inner shell 43 is pressed by the adapter 53 in a direction opposite to the insertion direction. Because the elastic body 43c is disposed on the flange 43b of the inner shell 43, when the inner shell 43 is pressed by the adapter 53, the elastic body 43c elastically deforms between the outer shell 44 and the flange 43b (see FIG. 2A). When the elastic body 43c elastically deforms, the elastic body 43c generates a restoring force that presses the inner shell 43 back toward the adapter 53. Generation of this restoring force facilitates automatic fitting of the adapter 53 and the optical connector 21 when attaching the optical probe 20. In the present embodiment, the elastic body 43c is attached to the inner shell 43. Alternatively, the elastic body 43c may be attached to the outer shell 44.

For example, the automatic fitting operation described above is performed when an operator, who has inserted the inner shell 43 and the outer shell 44 into the connection hole 12e, operates the operation panel 11. Alternatively, the driver 10 may detect insertion of the inner shell 43 and the outer shell 44, and then the controller 18 may automatically perform the automatic fitting operation.

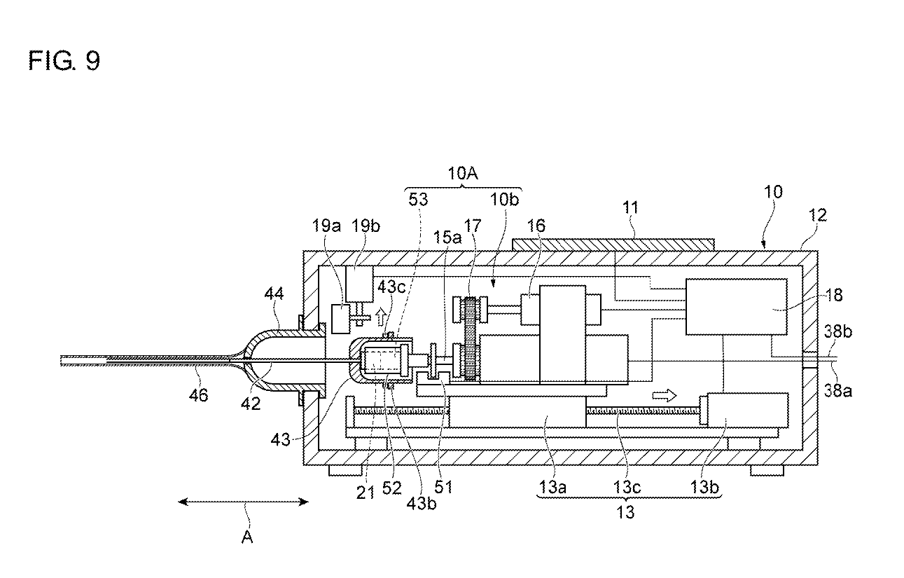

After finishing the automatic fitting operation, the controller 18 causes the motor 16 to rotate the optical connector 21 and the optical fiber 22, which is contained in the metal tube 42, and starts a scanning operation. The scanning operation is started by the operator operating the operation panel 11. As illustrated in FIG. 9, during the scanning operation, the controller 18 causes the stage 13 to gradually move the adapter 53 backward, thereby pulling out the optical connector 21 and the metal tube 42 (the optical fiber 22) (performing a pullback operation). When performing the pullback operation, the controller 18 moves the key member 19a to a position (withdrawn position) at which the key member 19a is disengaged from the cutout 43a of the inner shell 43. Thus, the inner shell 43 and the optical connector 21 are not engaged with the key member at the cutout 43a, and therefore, the optical connector 21 and the metal tube 42 (the optical fiber 22) can be pulled out. After finishing the scanning operation, the controller 18 stops the motor 16.

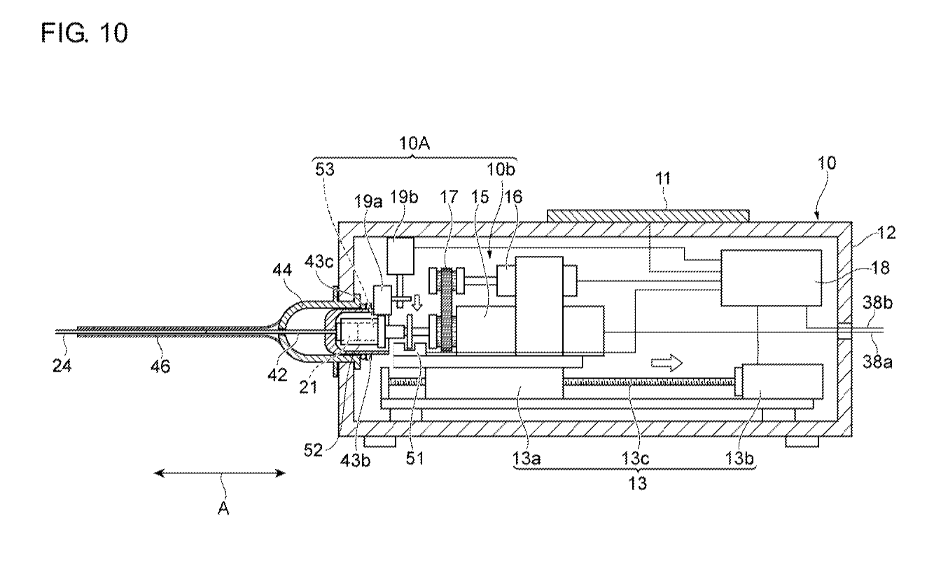

Next, an operation of removing the optical probe 20 from the driver 10 will be described. As illustrated in FIG. 10, the controller 18 causes the stage 13 to move the adapter 53 forward to return the inner shell 43 and the optical connector 21 to their original positions (see FIG. 8). Next, the controller 18 controls the angle of the adapter 53, which is detected by the rotation angle sensor 51, so that the rotational position of the cutout 43a coincides with the position of the key member 19a. Subsequently, the controller 18 causes the key member 19a to be moved to a position at which the key member 19a is inserted into the cutout 43a of the inner shell 43.

In this state, in which the inner shell 43 is not movable, the controller 18 causes the stage 13 to move the adapter 53 backward again. Thus, the optical connector 21 and the adapter 53 are decoupled from each other, and the adapter 53 is separated from the optical connector 21 (see FIG. 7). These series of operations are automatically performed when an operator presses an “UNLOAD” switch of the operation panel 11. After the series of operations have been finished, the operator rotates the outer shell 44 and extracts the inner shell 43 and the outer shell 44 from the connection hole 12e, thereby finishing the operation of removing the optical probe 20.

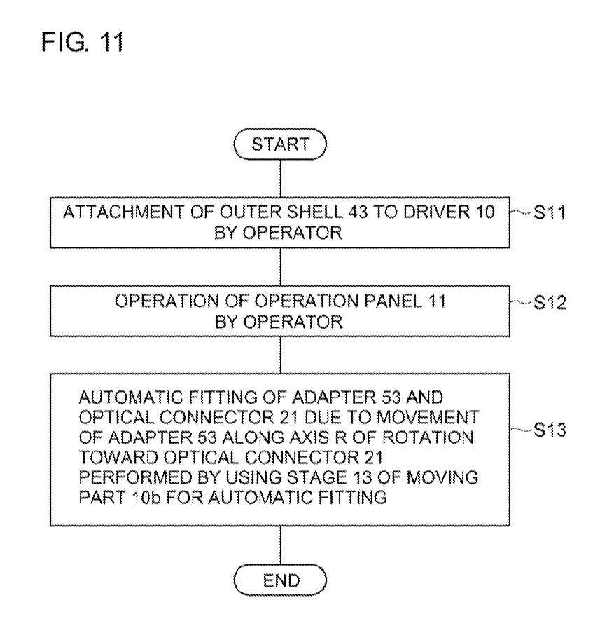

FIG. 11 is a flowchart representing the process of attaching the optical probe 20 to the driver 10. In the present embodiment, first, an operator inserts the outer shell 44 into the connection hole 12e of the driver 10, thereby attaching the outer shell 44 to the driver 10 (step S11, first step). Next, the operator operates the operation panel 11 (step S12). Lastly, the adapter 53 is moved by the stage 13 of the moving part 10b for automatic fitting along the axis R of rotation toward the optical connector 21, and the adapter 53 is automatically fitted to the optical connector 21 by using the restoring force of the elastic body 43c (step S13, second step).

With the optical probe 20 according to the present embodiment, when the OCT system 1 captures a tomographic image, the motor 16 rotates the optical fiber 22 and the supporting tube 23 via the adapter 53 and the optical connector 21. Therefore, a part of the inside of the body (such as a blood vessel) located around the optical probe is scanned, and a tomographic image of the part can be appropriately captured. When the optical connector 21 and the adapter 53 become connected to each other, the elastic body 43c, which is located between the inner shell 43 and the outer shell 44, elastically deforms by being pressed. Therefore, the optical connector 21 and the adapter 53 can be securely coupled to each other by a restoring force of the elastic body 43c. Accordingly, with the optical probe 20 according to the present embodiment, the optical connector 21 and the adapter 53 can be automatically fitted to each other securely and easily. Moreover, the flange 43b is disposed on the inner shell 43 in the optical probe 20 according to the present embodiment, and therefore, for example, the elastic body 43c, such as an O-ring, can be easily disposed between the inner shell 43 and the outer shell 44.

In the method of attaching the optical probe 20 according to the present embodiment, after an operator has attached the outer shell 44 to the case 12 of the driver 10, the stage 13 of the moving part 10b for automatic fitting moves the adapter 53 along the axis R of rotation toward the optical connector 21, and the adapter 53 contacts the optical connector 21. Then, automatic fitting is securely performed by using a restoring force of the elastic body 43c, which is disposed between the inner shell 43 and the outer shell 44. Thus, with the method of attaching the optical probe 20 according to the present embodiment, automatic fitting can be easily performed.

### First Modification

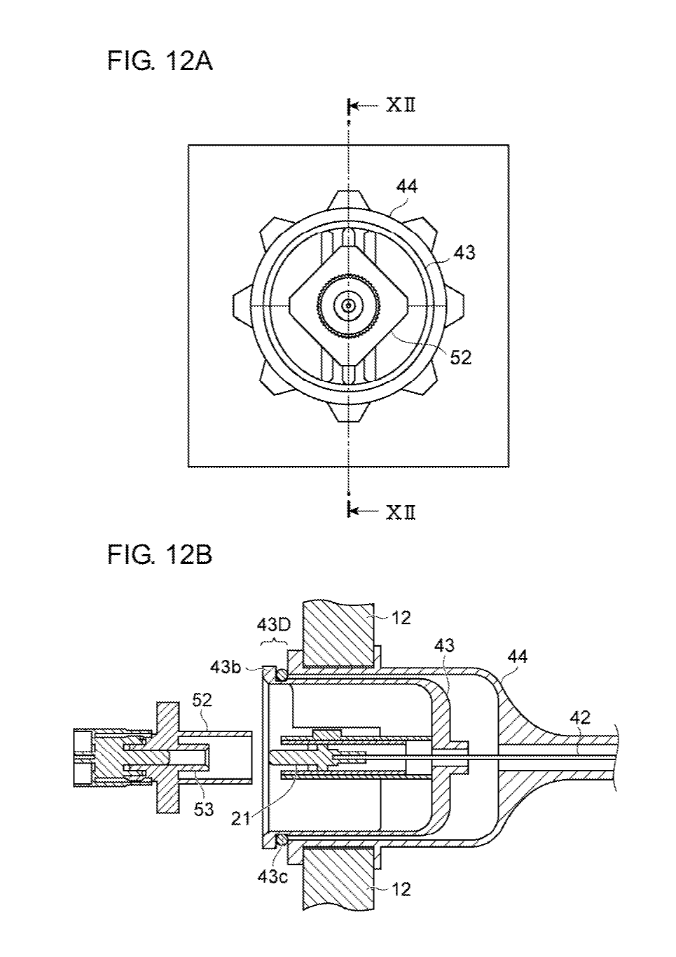

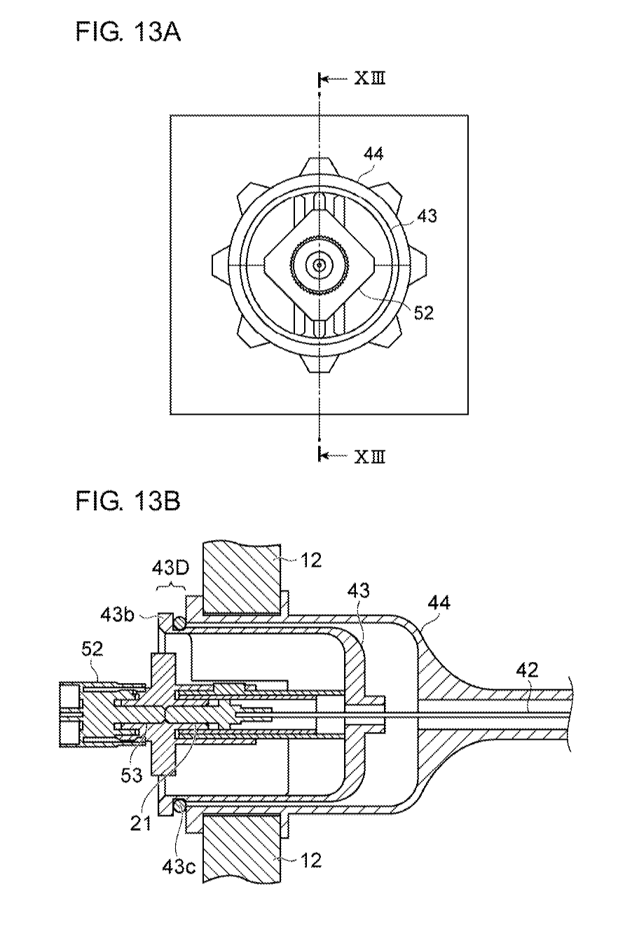

FIGS. 12A to 13B are conceptual diagrams illustrating a first modification of the present embodiment. Each of FIGS. 12A and 13A is each a front view of an end of an optical probe 20 seen from an opening in an outer shell 44, and FIGS. 12B and 13B are respectively sectional views taken along lines XIIB-XIIB and XIIIB-XIIIB of FIGS. 12A and 13A. FIGS. 12A and 12B are conceptual diagrams illustrating a state before an adapter 53 and an optical connector 21 contact each other. FIGS. 13A and 13B are conceptual diagrams illustrating a state after the adapter 53 and the optical connector 21 have been fitted to each other.

In the present modification, an inner shell 43 does not have the cutout 43a. Moreover, a flange 43b of the inner shell 43 is disposed along an opening 43D of the inner shell 43, and the positions of an end face of the flange 43b and the plane of the opening of the inner shell 43 coincide with each other in the axial direction. The flange 43b extends along a plane perpendicular to the longitudinal direction of the optical probe 20. The outside diameter of the flange 43b is greater than the inside diameter of the outer shell 44.

Also with the present modification, the adapter 53 and the optical connector 21 can be automatically fitted to each other securely. In other words, after the adapter 53 and the optical connector 21 have automatically approached each other, the adapter 53 and the optical connector 21 can be automatically fitted to each other securely and easily by a restoring force generated by elastic deformation of the elastic body 43c.

### Second Modification

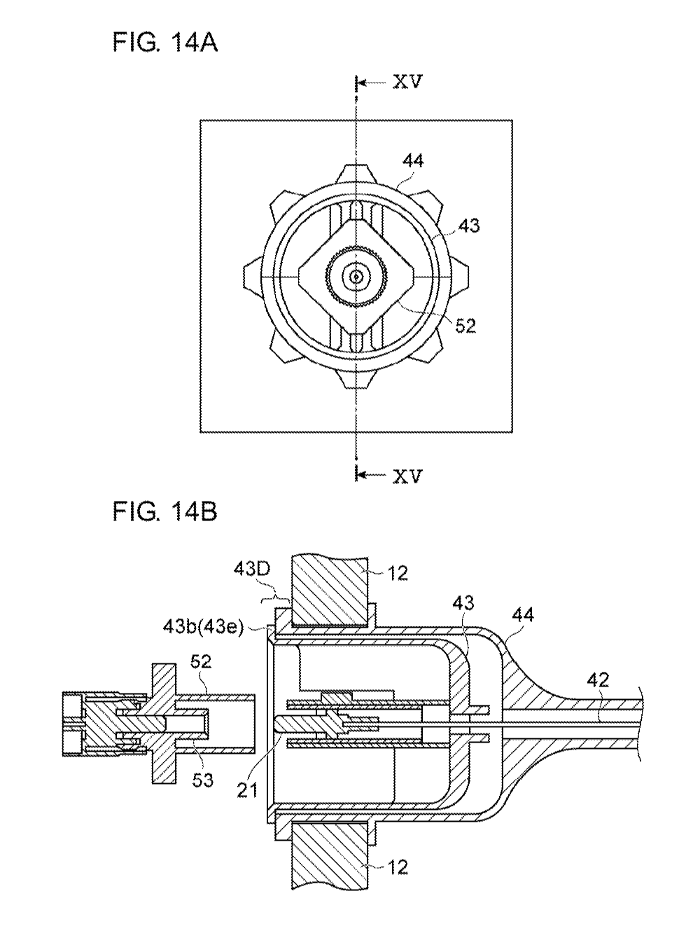

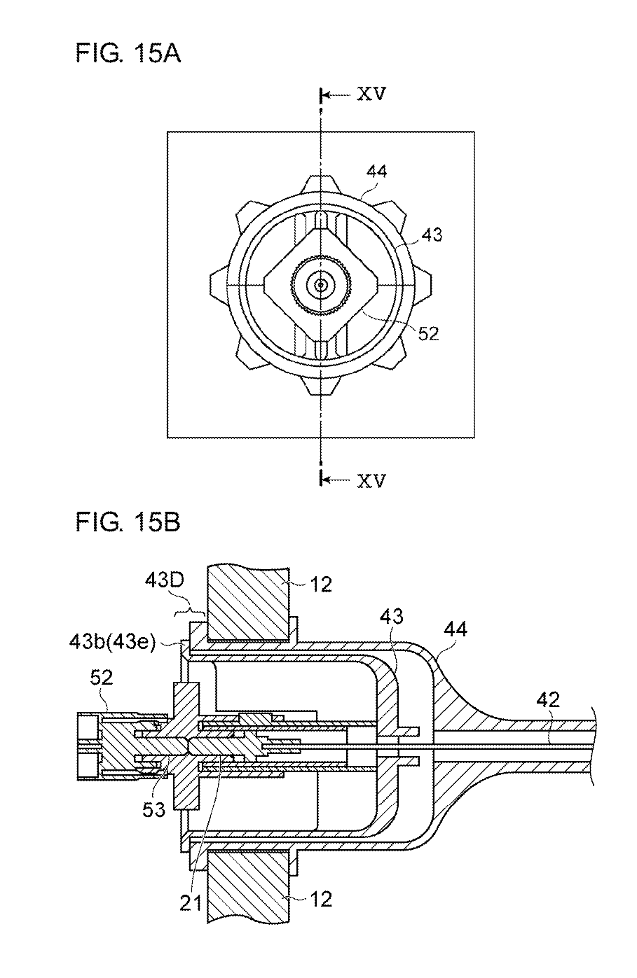

FIGS. 14A to 15B are conceptual diagrams illustrating a second modification of the present embodiment. Each of FIGS. 14A and 15A is a front view of an end of an optical probe 20 seen from an opening in an outer shell 44, and FIGS. 14B and 15B are respectively sectional views taken along lines XIVB-XIVB and XVB-XVB of FIGS. 14A and 15A. FIGS. 14A and 14B are conceptual diagrams illustrating a state before an adapter 53 and an optical connector 21 contact each other. FIGS. 15A and 15B are conceptual diagrams illustrating a state after the adapter 53 and the optical connector 21 have been fitted to each other.

In the embodiment and the first modification, the elastic body 43c is an independent member attached to the outer periphery of the inner shell 43. Alternatively, a structure that elastically deforms may be provided as a part of the inner shell 43 or the outer shell 44. In other words, such an elastic structure is integrally formed with the inner shell 43 or the outer shell 44. For example, as illustrated in FIGS. 14A to 15B, a part of the flange 43b of the inner shell 43 near the opening 43D of the inner shell 43 may be cut so as to reduce the thickness thereof, and the thinned part may be used as an elastic structure 43e. In this case, the elastic structure 43e elastically deforms when the inner shell 43 and the outer shell 44 contact each other in an automatic fitting operation. Therefore, the elastic structure 43e can generate a restoring force in the same way as the elastic body 43c, such an O-ring, in the embodiment and the first modification does.

Accordingly, also with the present modification, the adapter 53 and the optical connector 21 can be automatically fitted to each other securely by a restoring force of the elastic structure 43e. Accordingly, the optical connector 21 and the adapter 53 can be automatically fitted to each other securely and easily.

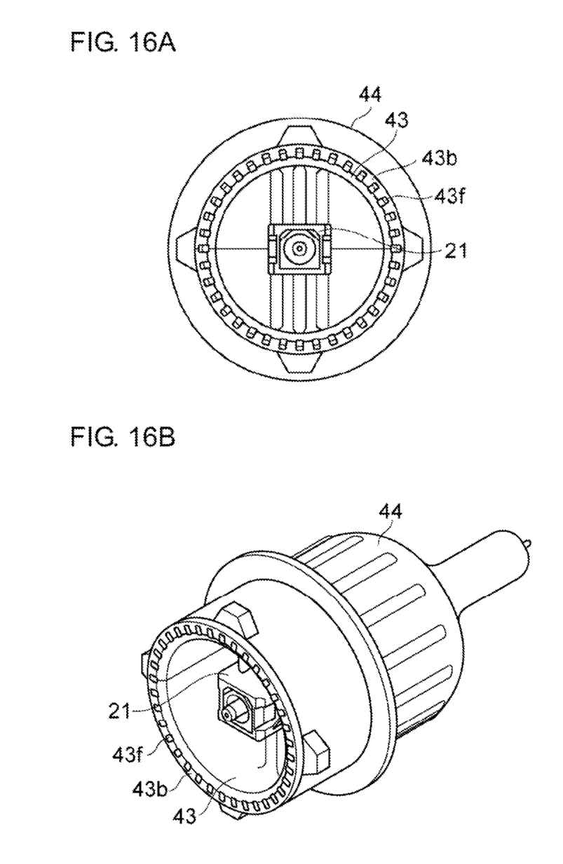

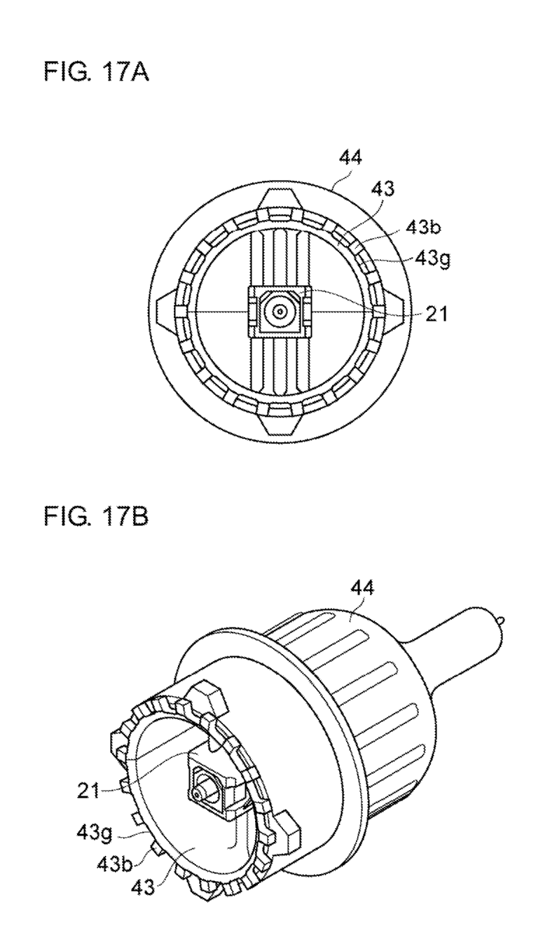

Each of FIGS. 16A and 17A is a front view of an end of an optical probe 20 according to a further modification of the second modification seen from an opening in an outer shell 44. Each of FIGS. 16B and 17B is a perspective view of an inner shell 43 and the outer shell 44. FIGS. 16A to 17B illustrate examples of a structure with which elastic deformation of the elastic structure 43e (see FIGS. 14A to 15B) is adjusted further. In FIGS. 16A to 17B, slits 43f and cutouts 43g are formed in the flange 43b so as to extend from an inner peripheral surface toward an outer peripheral surface of the inner shell 43. The slits 43f and the cutouts 43g can adjust elastic deformation. Therefore, as a structure for adjusting elastic deformation of the elastic structure 43e (see FIGS. 14A to 15B), for example, it is preferable that the slits 43f or the cutouts 43g be formed in the flange 43b.

What is claimed is:

1. An optical probe comprising:
an optical fiber that rotates around an axis of rotation and that transmits light;
an optical connector that is connected to an end face of the optical fiber and that rotates together with the optical fiber around the axis of rotation;
a supporting tube that surrounds the optical fiber and that rotates together with the optical fiber around the axis of rotation;
a jacket tube that covers the supporting tube;
an inner shell that is attached to the supporting tube, that surrounds the optical connector around the axis of rotation, and that rotates together with the optical fiber around the axis of rotation;
an outer shell that is attached to the jacket tube and that surrounds the inner shell around the axis of rotation; and
an elastic body that is attached to one of the inner shell and the outer shell and that elastically deforms between the inner shell and the outer shell.

2. The optical probe according to claim 1,
wherein the inner shell includes a flange,
wherein the flange has a facing surface that faces the outer shell, and
wherein the elastic body is disposed on the facing surface.

3. An optical probe comprising:
an optical fiber that rotates around an axis of rotation and that transmits light;
an optical connector that is connected to an end face of the optical fiber and that rotates together with the optical fiber around the axis of rotation;
a supporting tube that surrounds the optical fiber and that rotates together with the optical fiber around the axis of rotation;
a jacket tube that covers the supporting tube;
an inner shell that is attached to the supporting tube, that surrounds the optical connector around the axis of rotation, and that rotates together with the optical fiber around the axis of rotation; and
an outer shell that is attached to the jacket tube and that surrounds the inner shell around the axis of rotation,
wherein at least one of the inner shell and the outer shell includes an elastic structure that is integrally formed with the inner shell or the outer shell, at least a part of the elastic structure elastically deforming when the inner shell and the outer shell contact each other.

4. The optical probe according to any one of claim 1 to be attached to a driver,
wherein the driver includes
an automatic-fitting portion including a moving part for automatic fitting and an adapter, and
a case containing the automatic-fitting portion,
wherein the moving part for automatic fitting includes a stage that moves the adapter along the axis of rotation and a motor that rotates the adapter around the axis of rotation,
wherein the adapter becomes coupled to the optical connector by movement of the stage along the axis of rotation,
wherein the inner shell rotates around the axis of rotation as the motor rotates the adapter around the axis of rotation, and
wherein the outer shell is detachably attached to the case.

5. A method of attaching the optical probe according to claim 4 to the driver, the method comprising:
a first step of attaching the outer shell to the case of the driver, and
a second step of automatically fitting the adapter to the optical connector by moving the adapter along the axis of rotation toward the optical connector by using the stage of the moving part for automatic fitting.

6. The optical probe according to any one of claim 3 to be attached to a driver,
wherein the driver includes
an automatic-fitting portion including a moving part for automatic fitting and an adapter, and
a case containing the automatic-fitting portion,
wherein the moving part for automatic fitting includes a stage that moves the adapter along the axis of rotation and a motor that rotates the adapter around the axis of rotation,
wherein the adapter becomes coupled to the optical connector by movement of the stage along the axis of rotation,
wherein the inner shell rotates around the axis of rotation as the motor rotates the adapter around the axis of rotation, and
wherein the outer shell is detachably attached to the case.

7. A method of attaching the optical probe according to claim 6 to the driver, the method comprising:
a first step of attaching the outer shell to the case of the driver; and
a second step of automatically fitting the adapter to the optical connector by moving the adapter along the axis of rotation toward the optical connector by using the stage of the moving part for automatic fitting.
